(19) United States
(12) Patent Application Publication
(10) Pub. No.: US 2014/0331876 A1
(43) Pub. Date: Nov. 13, 2014

(54) IN-LINE INTEGRATED RAISED PRINTING

(71) Applicants: Itzik Shaul, Nes Ziona (IL); George Trendafilov, Nes Ziona (IL); Gilad Greenberg, Nez Ziona (IL); Shaun Henry, Middleton, ID (US); Gregory Doyle Creager, Boise, ID (US)

(72) Inventors: Itzik Shaul, Nes Ziona (IL); George Trendafilov, Nes Ziona (IL); Gilad Greenberg, Nez Ziona (IL); Shaun Henry, Middleton, ID (US); Gregory Doyle Creager, Boise, ID (US)

(21) Appl. No.: 14/355,097

(22) PCT Filed: Oct. 31, 2011
(86) PCT No.: PCT/US2011/058557

§ 371 Date: Apr. 29, 2014

(51) Int. Cl. B41M 1/18

(52) U.S. Cl. CPC B41M 1/18
USPC 101/211; 101/171

(57) ABSTRACT

A method for in-line integrated raised printing. The method includes performing a plurality of separations, and generating a height of an in-line integrated raised print based on the performing the plurality of separations without requiring off-line printing activities.

### BACKGROUND

Thermographic or raised printing utilizes post-process techniques. Typically, thermographic printing is performed by removing a print medium from a printer and utilizing off-line processes to generate the raised printing. The off-line processes can include additional equipment and specialized methods such as thermal processing that includes specialized powder. Accordingly, the off-line processes to generate the raised printing increases the time and cost for generating the raised printing.

### BRIEF DESCRIPTION OF THE DRAWINGS

FIG. 1 illustrates an embodiment a printer.

FIGS. 2A-C illustrates embodiments of raised printing.

FIG. 3 illustrates an embodiment of a method for in-line integrated raised printing.

The drawings referred to in this description should be understood as not being drawn to scale except if specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

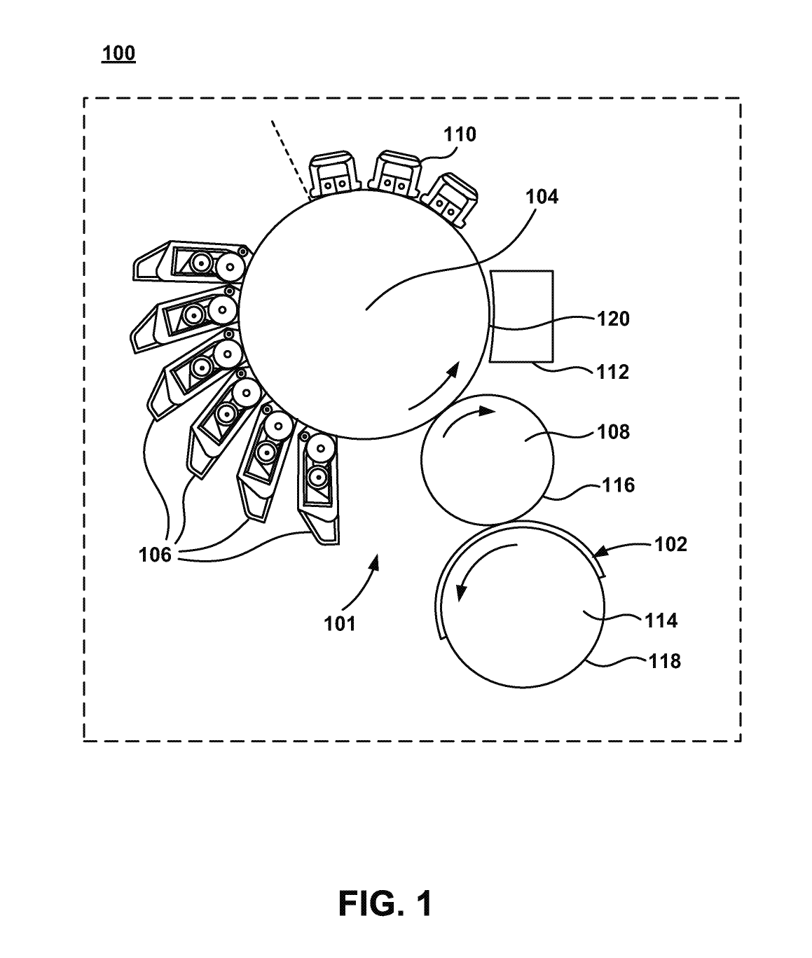

FIG. 1 depicts an embodiment of printer 100. In general, printer 100 is configured to print an image on print medium 102. In one embodiment, printer 100 comprises print engine 101.

Print engine 101 is configured for performing a plurality of separations, and generating a height of an in-line integrated raised print based on the performing the plurality of separations without requiring off-line printing activities, which will be described in further detail below. In one embodiment, print engine 101 utilizes an electro-statographic printing process.

In one embodiment, print engine 101 includes a photo imaging plate (PIP) 104, an ITM 108 or blanket cylinder, and impression roller 114.

Operationally, PIP 104 or photoreceptor is given a uniform charge by at least one charge unit 110. This uniform charge is selectively discharged to form a latent electrostatic image by, for example a light beam shown as a dashed line, which scans across PIP 104 as it rotates in the direction shown, The selective discharging on PIP 104 forms a latent image that corresponds to an image which is to be printed by print engine 101. Liquid toner is optionally discharged from at least one binary image developer (BID) 106 which adheres to the appropriately charged areas of PIP 104, thereby developing the latent image.

The developed image is first transferred to ITM 108 and heated on ITM 108. The developed image is then transferred, in a second transfer, to a print medium 102 (e.g., paper).

PIP 104 is optionally discharged and cleaned by a cleaning/discharging unit 112 prior to recharging of PIP 104 in order to start another printing cycle. As print medium 102 passes by ITM 108, the image located on surface 116 of ITM 108 is then transferred and affixed to print medium 102. Affixation of the image to print medium 102 is facilitated by locating print medium 102 on surface 118 of impression roller 114, which applies pressure to print medium 102 by compressing it between impression roller 114 and ITM 108 as the image is being transferred to print medium 102. Eventually, print medium 102 bearing the image exits printer 100. Printer 100 can be, but is not limited to, a sheet-fed printer, a web-fed printer, an HP Indigo press, etc.

In one embodiment, each BID 106 contains a different color toner, for use in producing multi-color images. However, in various embodiments, BIDs 106 units are not used for depositing toner on PIP 104 and other development methods and/or other image formation methods are used. It should be understood that the foregoing print engine description is provided by way of example only, and that print blankets described herein are suitable for use with a variety of liquid toner print engines.

Also, in one embodiment, ITM 108 is maintained at a suitable voltage and temperature for electrostatic transfer of a toner image thereto from an image-bearing surface, such as a photoreceptor surface. The image is then transferred from ITM 108 onto a print medium 102 by heat and pressure.

It should be appreciated that printer 100 can generate an image on print medium 102 by other printing means that are well known in the art.

Printer 100 is able to create a “raised print,” In general, a raised print involves raising a surface of ink above the image level (e.g., above the surface of the print medium) or generating an appearance that the surface of the ink is above the image level to create a textural and/or visual effect.

Printer 100 is able to generate in-line integrated raised printing based, in part, on the same printing processes as described above. In other words, printer 100 generates a raised print by a plurality of linked printing processes solely by printer 100. That means that printer 100 creates a raised print without requiring off-line printing activities. Accordingly, no special press set-up or off-line activities are required in order to create a raised print.

In contrast, conventional raised printing methods require that the raised printing be generated by off-line processes. For example, a raised print is created by thermal process using special powder via several off-line stations.

In particular, printer 100 creates the raised printing by performing a plurality of separations in series without reinsertion of print medium 102. In various embodiments, the raised printing is accomplished by adjusting the process parameters (e.g., pressure, temperature, voltage, etc.) with respect to print engine 101.

In one embodiment, raised printing can be performed in conjunction with embossing. Additionally, no special set-up is needed such as, molds, dies, which may be required in embossing methods.

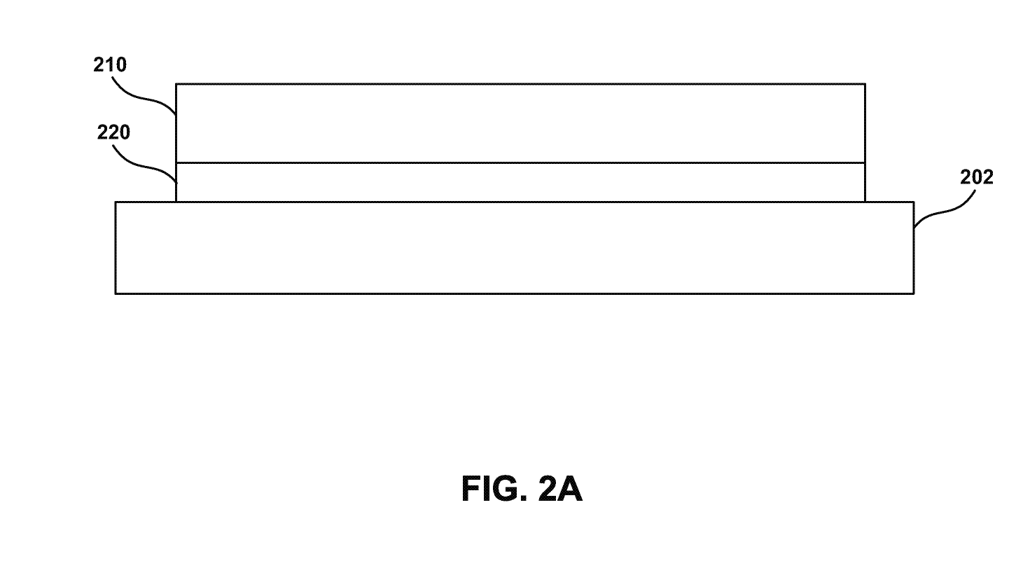

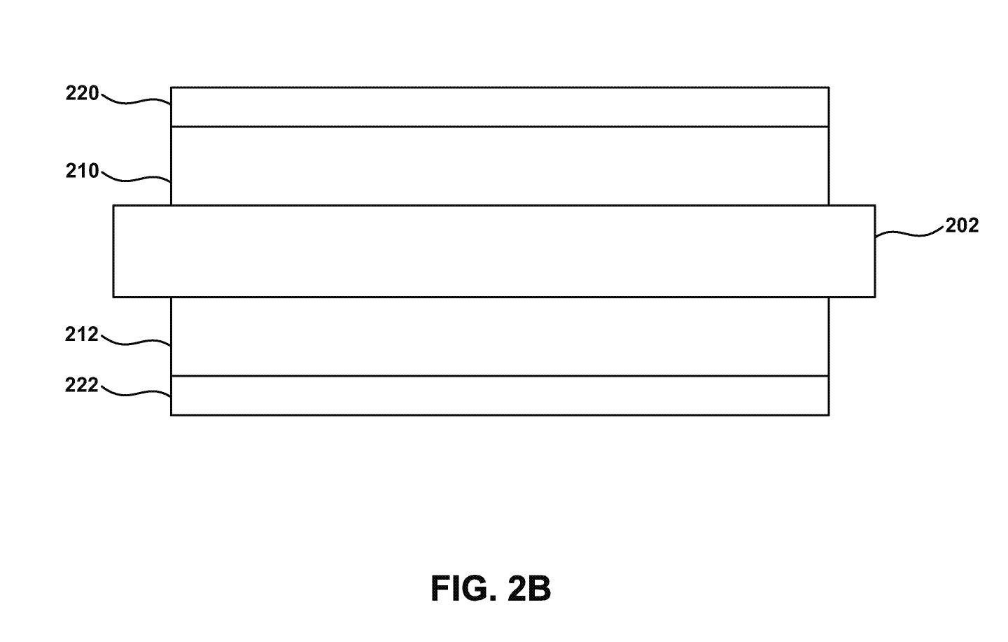

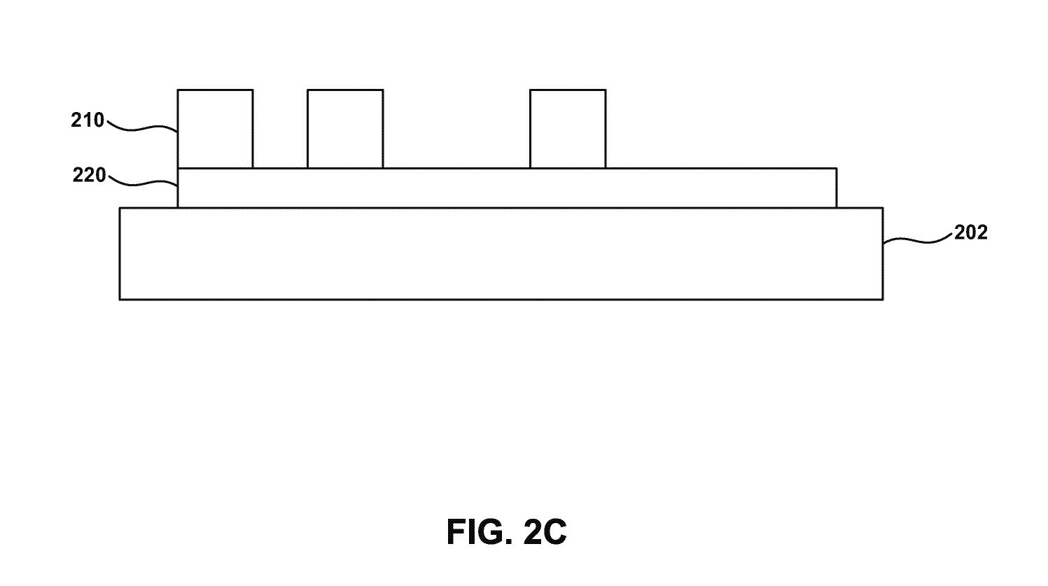

FIGS. 2A-C depicts embodiments of raised print that is created by printer 100. FIG. 2A depicts print medium 202, raised print 210 and image 220. In this embodiment, image 220 is a CMYK image that is printed onto print medium 202 by a “regular” printing process, as described in detail above. CMYK refers to the four inks used in color printing: cyan, magenta, yellow, and black.

To create the raised print effect, raised print 210 is printed above image 220. Raised print 210 can be, but is not limited to, a transparent ink (e.g., digital matte ink), varnish, etc.

Raised print 210 can be generated by a plurality of printed separations. In other words, a plurality of layers and print repetitions creates raised print 210.

The number of repetition/layers can be defined by the user in order to achieve a desirable quality. For example, the user can decide to print from 1 up to 64 layers or more for a desired quality.

FIG. 2B depicts raised print 210 printed directly onto print medium 202 by raised print methods and image 220 is printed on top of raised print 210 by regular print methods. In one embodiment, raised print 210 is opaque ink (e.g., white ink).

FIG. 2B also depicts duplex printing of a raised print. For example, raised print 212 is printed on the opposite side of print medium 202 than raised print 210. Also, image 222 is printed on top of raised print 212.

FIG. 2C depicts image 220 printed onto print medium 202. Raised print 210 is selectively printed onto image 220. In this embodiment, raised print is a spot color or a basic color formed as a raised area, It should be understood that raised print 210 can be selectively disposed in any pattern that is compatible with creating a raised print effect.

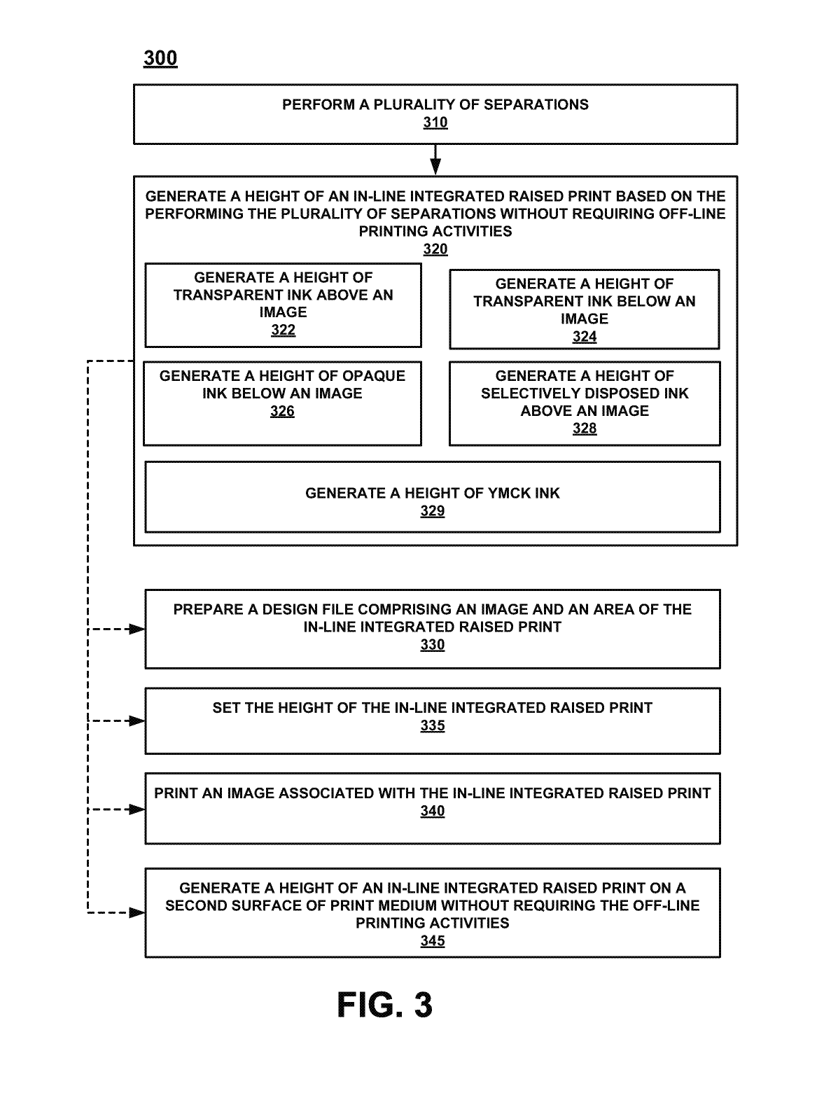

FIG. 3 depicts an embodiment of method 300 for in-line integrated raised printing. In various embodiments, method 300 is carried out by processors and electrical components under the control of computer readable and computer executable instructions. The computer readable and computer executable instructions reside, for example, in a data storage medium such as computer usable volatile and non-volatile memory, However, the computer readable and computer executable instructions may reside in any type of computer readable storage medium. In some embodiments, method 300 is performed at least by printer 100, as depicted in FIG. 1.

At 310 of method 300, a plurality of separations are performed. For example, a plurality of separations are performed by printer 100 to generate raised print 210.

At 320, a height of an in-line integrated raised print is generated based o the performing the plurality of separations without requiring off-line printing activities. For example, a height of in-line integrated raised print 210 is created based on the plurality of separations performed. In particular, the height of in-line integrated raised print 210 is generated without requiring off-line printing activities such as using off-line thermal processes.

In one embodiment, the height of raised print 210 is determined by user input. For example, if a user requests that 50 layers are performed, and each layer is 1 μm, then the raised print will have a height of 50 μm.

In one embodiment, a 322, a height of transparent ink is generated above an image. For example, with reference to FIG. 2A, raised print 210 (e.g., transparent ink) is disposed on top of image 220.

In one embodiment, at 324, a height of transparent ink is generated below an image. For example, with reference to FIG. 2B, raised print 210 (e.g., transparent ink) is disposed below of image 220. In another embodiment, at 326, a height of opaque ink is generated below an image. For example, raised print 210 (e.g., opaque white ink) is generated below image 220.

In a further embodiment, at 328, height of selectively disposed ink is generated above an image. For example, with reference to FIG. 2C, raised print 210 (e.g., selectively disposed ink) is generated above image 220. In another embodiment, at 329, a height of raised print 210 (e.g., YMCK ink) is generated above image 220.

At 330, a design file comprising an image and an area of the in-line integrated raised print is prepared. For example, a user generates a design file that includes image 220 and an area of in-line integrated raised print 210.

At 335, a height of the in-line integrated raised print is set. For example, a height of 50 microns is set at the height of the in-line integrated raised print 210. It should be appreciated that the height is indicative of the number of layers or separations.

At 340, an image associated with the in-line integrated raised print is printed. For example, image 220 is printed by regular methods by printer 100 and is associated with raised print 210.

At 345, a height of an in-line integrated raised print is generated on a second surface of print medium without requiring the off-line printing activities. For example, with reference to FIG. 28, a duplex of raised print is generated. In such an example, raised print 212 is printed on an opposite of print medium 202 than raised print 210.

Various embodiments of the present invention are thus described. While the present invention has been described in particular embodiments, it should be appreciated that the present invention should not be construed as limited by such embodiments, but rather construed according to the following

1. A method for in-one integrated raised printing, said method comprising:
performing a plurality of separations; and
generating a height of an in-line integrated raised print based on said performing said plurality of separations without requiring off-line printing activities.

2. The method of claim 1, further comprising:
preparing a design file comprising an image and an area of said in-line integrated raised print.

3. The method of claim 1, further comprising:
setting said height of said in-line integrated raised print.

4. The method of claim 1, further comprising:
printing an image associated with said in-line ii rated raised print.

5. The method of claim 1, wherein said generating a height of said in-line integrated raised print comprises:
generating a height of transparent ink above an image.

6. The method of claim 1, wherein said generating a height of said in-line integrated raised print comprises:
generating a height of transparent ink below an image.

7. The method of claim 1, wherein said generating a height of said in-line integrated raised print comprises:
generating a height of opaque ink below an image.

8. The method of claim 1, wherein said generating a height of said in-line integrated raised print comprises:
generating a height of selectively disposed ink above an image.

9. The method of claim 1, wherein said generating a height of said in-line integrated raised print comprises:
generating a height of YMCK ink.

10. The method of claim 1, further comprising:
generating a height of an in-line integrated raised print on a second surface of print medium without requiring said off-line printing activities.

11. The method of claim 1, wherein said height is determined by user input.

12. A printer for in-line integrated raised printing comprising:
a printing engine for performing a plurality of separations, and for generating a height of an in-line integrated raised print based on said performing said plurality of separations, without requiring off-line printing activities.

13. The printer of claim 12, wherein said height is approximately 50 microns and is determined by user input.

14. The printer of claim 11, wherein said raised print Comprises:
transparent ink.

15. The printer of claim 11, wherein said raised print comprises:
white ink.
